(19) United States
(12) Patent Application Publication
(10) Pub. No.: US 2005/0171822 A1
(43) Pub. Date: Aug. 4, 2005

(54) Responsive confidence scoring method for a proposed valuation of aproperty

(75) Inventor: Christopher L. Cagan, Los Angeles, CA (US)

Correspondence Address: Marshall A. Lerner, Esq.;Kleinberg & Lerner, LLP, Suite 1080, 2049 Century Park East,, Los Angeles, CA, 90067, US

(73) Assignee: First American Real Estate Solutions, L.P.

(21) Appl. No.: 10/771,069

(22) Filed: Feb. 3, 2004

(51) Int. Cl. G06F 17/60

(52) U.S. Cl. 705/7

(57) ABSTRACT

A method of computing a confidence score in response to a suggested valuation of a property such as a home or townhouse, using a computer system. A customer identifies a property and suggests its valuation to the computer system. Using an automated valuation model, the computer system computes an automated valuation of the property and an automated confidence score in that valuation. The computer system also computes a percentage difference between the automated valuation and the suggested valuation. With this difference and with the automated confidence score, the computer system consults a reference table from which it retrieves a responsive confidence score which is then reported to the customer. The computer system prepares the reference table using an algorithm based on an automated valuation model and historical sale price data.

### BACKGROUND OF THE INVENTION

1. Field of the Invention

The present invention relates to a method of computing a responsive confidence score in evaluating real property. More particularly, the present invention relates to a method of computing a responsive confidence score in response to a suggested valuation of a house, townhouse, or condominium.

2. Description of the Related Art

Existing automated valuation models (“AVMs”) estimate the market value of a subject piece of real property (the “subject property”) at a certain time. An AVM may adjust value to account for differences between characteristics of the subject property and those of comparable nearby properties for which actual sale prices are known. This is the most basic form of appraisal emulation. Furthermore, an AVM may also use established indices of price appreciation based on paired sales or other methods. An AVM may also use neural net technology or other methods.

Professionals in the real estate industry recognize that valuations of a property may vary under the influence of such factors as the psychology and personal and financial circumstances of a buyer and seller, the input of real estate agents and brokers, and property characteristics such as details, decorations, and other special features not likely to be included in any database. For example, a residence may have been purchased in 1990 for $237,000. The original agreed price was $230,000. However, after inspection revealed defects, the seller arranged to raise the price to $237,000 and to rebate $7,000 to the buyer at the close of escrow. The recorded purchase price of $237,000 does not provide any indication whether the true purchase price was $237,000 as recorded or $230,000. This difference, about three percent of the transaction value, exemplifies just one of many irregularities tending to introduce uncertainty into the valuation of a property based on comparable sales. Virtually identical properties have been known to sell for prices different by 5% and sometimes even 8%, or more. The factors underlying the price difference are often not available from any database.

Similarly, even the most exacting and honest professional appraisers, having investigated a subject property and having compared it to nearby and similar recently sold properties, may arrive at different valuations.

Thus, valuations assigned by different AVMs will commonly differ by several percent. Even a hypothetically well designed AVM would have no better accuracy and no less degree of variation than that of full physical appraisals—and, almost by definition, be no more accurate than the actual market of sale prices themselves. Even in a good data environment, a geographic area with many sales of similar properties, such as a suburban area dominated by tract homes, AVM variances (the percentage that an AVM valuation is above or below an actual sale price) may have a standard deviation of eight to twelve percent and a median magnitude (absolute value) of these variances (high or low) of nine to fourteen percent. It is thus not surprising that almost all AVMs supply to the user not only an assigned valuation but also a measure of the certainty or uncertainty associated with that valuation.

One simple measure of uncertainty is a range, where the AVM values a property at, for instance, $300,000, within a range of $240,000 to $360,000 (plus or minus twenty percent from the central valuation). The spread of that valuation range may be larger or smaller depending on the confidence the AVM places in the valuation itself—which in turn depends on the quantity, quality, and homogeneity of the underlying database of sold comparable properties (“comps”).

Alternatively, an AVM may provide a confidence score of one type or another. The confidence score may be in the form of a letter grade, such as A through D, or words such as “High,” “Medium” and “Low,” which represent the degree of confidence or accuracy that an AVM valuation may be expected to possess. Alternatively, the AVM may provide a subjective numerical score, perhaps from 0 to 100, a higher score indicating a greater degree of confidence in the valuation. The score itself does not represent any dollar amount or percentage of expected variance in valuation.

Alternatively, the confidence score may be an objective numerical score reflecting a measure of spread—a measure of the variance in valuation. These scores most often measure the standard deviation of the variance or the mean or median absolute value of the variances. In preparation for assigning such scores, an AVM vendor may divide a large sample of properties into several or many subsets according to confidence-related characteristics, i.e., the extent of available data, the number of comparable sales and their proximity and likeness to the subject property, and so on. The variances of AVM valuation from sale price are computed for each subject property, and then the standard deviation of variance or mean or median absolute variance is computed for each subset, which is used to derive a confidence score. In some cases, each individual subject property is immediately assigned its own confidence score based on the extent, quality, and homogeneity of its supporting data set. However, the principle is similar to what has already been described.

Further alternatively, the confidence score may be given in the form of an objective numerical score reflecting a measure of the risk of default loss, namely a measure of the probability that a given AVM valuation suggests that a danger of loss exists to a lender in the event of a later default, foreclosure, and resale. One such confidence score is produced by First American Real Estate Solutions (“FARES”) in the ValuePoint®4 (“VP4”) model. This score represents the probability that an AVM valuation exceeds the market price by ten percent or more. Better valuations will have a smaller probability of such a large error than will valuations supported by few comparable sales or an otherwise weak data environment. The mathematical architecture focuses on the risk of loss itself and thus measures only the size of the right tail of overvaluations. The confidence score based on this method provides a measurement of the probability that the AVM is overvalued by a predetermined percentage or more. In the case of VP4, the predetermined percentage is 10%. The predetermined overvaluation percentage is referred to as the right tail overvaluation percentage because it is located at the right trailing edge of the distribution or probability curve of the percentage variances of the valuations above and below the sale price.

The right tail method of computing confidence scores does not in itself specify explicitly the standard deviation of variances or the median absolute variance. Also, this score does not measure the probability that the buyer will default, but the probability that a default, if it occurs, will result in loss to a lender who has lent 90% of the declared valuation of the property. However, the merit of the right tail approach can be highly useful to a lender, to whom exposure in the case of default is a paramount consideration, sometimes the dominant one.

All of these AVM valuations and their associated confidence scores are similar in that they supply a single valuation, henceforth referred to as a “directive” valuation, and a single confidence score, henceforth referred to as a “directive” confidence score, as output to the user. The user faces a “take it or leave it” situation. Sometimes the valuation and confidence score are entirely satisfactory to the user, but often the situation can be highly frustrating.

For instance, a buyer has offered $306,000 for a property with $30,600 (ten percent) down, asking for a mortgage of $275,400 (ninety percent of the sale price). After investigating the creditworthiness of the applicant, a lender is willing to make a “ninety percent loan” to the buyer. However, an AVM assigns a valuation to this property of only $300,000, with a confidence score of 85 (which, in the case of the FARES VP4 confidence score, would suggest a 15% probability that this valuation of $300,000 is 10% or more too high). The AVM valuation would support a “ninety percent loan” of only $270,000.

This lender faces several undesirable alternatives:
Make the requested loan anyway and incur the additional risk of possible default exposure later, if the lender retains the loan rather than reselling it on the secondary market;
Make the requested loan anyway and incur the risk that the loan cannot be resold at all on the secondary market or can only be sold on inferior terms and at a discounted price;
Decline the loan and risk losing the deal to another lender, with consequent loss of origination and other fees, and loss of future interest income, and loss of monetary gain if the loan is later resold on favorable terms;
Request that the buyer increase the down payment by $5,400 and risk losing the deal.

This undesirable situation can arise with any AVM, regardless of how it computes valuations and regardless of how it derives its confidence score. It can also arise with a conventional appraisal.

### SUMMARY OF THE INVENTION

In accordance with these objects and with others which will be described and which will become apparent, an exemplary method, in accordance with the present invention, for computing a confidence score in response to a suggested valuation of a subject property, using a computer system, includes the steps of inputting into the computer system identity data of the subject property; inputting into the computer system a user-supplied suggested valuation (for instance, an agreed-on sale price in a purchase mortgage application, or a requested valuation in a refinance application) of the subject property; computing a directive valuation of the subject property; computing a directive confidence score for the directive valuation; computing a percentage difference between the directive valuation and the suggested valuation; inputting the directive valuation, suggested valuation, the percentage difference between them, and the directive confidence score, into a reference table; and computing a confidence score, henceforth referred to as the responsive confidence score, associated with the suggested valuation of the subject real property.

In accordance with the present invention, the user supplies a property address or identifier and a suggested valuation. The AVM then responds with a responsive confidence score or, if the suggested valuation is unacceptably high or low so that no proper confidence score can be supplied, with a message to that effect.

In the example above, in which a property was valued at $300,000 with a confidence score of 85, the present invention has the capability to respond in the following ways. The numbers given are supplied as illustrations rather than as absolutely fixed or literal values:
Respond to a suggested valuation of $300,000 with a confidence score of 85 (as before).
Respond to a suggested valuation of $294,000 with a confidence score of 90. A lower valuation is less likely to incur loss, or will incur smaller loss, in the case of default, hence the responsive confidence score will be higher.
Respond to a suggested valuation of $306,000 with a confidence score of 77. A higher valuation is more likely to be “too high” and more likely to incur loss, and greater loss, in the event of a default, hence the responsive confidence score will be lower.
Respond to a suggested valuation of $400,000 with no confidence score at all and a message that this number is too high to return a confidence score, and hence the loan should be declined or otherwise re-evaluated.

In the example discussed above the user, such as a lender, would receive a response to the requested valuation of $306,000 in the form of a confidence score of 77. The lender may find this responsive confidence score of 77 to be acceptable and proceed with the loan, or the lender may be uncomfortable with that response. However, a response has been given, tailored to the lender's requested valuation. The lender may then proceed immediately, without further delay or consultation, with this valuation and this confidence score, or return to the buyer or loan applicant with new proposed terms, or decide not to proceed at all. In the case the lender decides to proceed, valuable time and money have been saved. In any event, the lender has received some indication of the degree to which the requested valuation is risky or otherwise should not be accepted.

In accordance with the present invention the response or responses may be delivered in various ways. The method in accordance with the present invention is especially appropriate to, and benefits from, the VP4 right tail method of computing a confidence score. A responsive confidence score derived from a center spread or letter grade or other algorithmic approach will be mathematically much weaker, harder to derive, more prone to error, more difficult to work with, and less helpful to the user, client or customer, than is a responsive confidence score derived from the VP4 right tail methodology.

The method in accordance with the present invention recognizes and uses the distributed or probability curve nature of valuation and of price itself and makes that characteristic into a positive and useful resource of use and value to a customer.

The responsive approach to AVM valuation and confidence scoring recognizes the fact that valuations are in fact better described by an extended distribution or probability curve reaching out, symmetrically or not, above and below a reasonable center level, rather than described only in terms of a single price point, and that market price levels themselves are also better described by an extended distribution than a single price point.

Also in accordance with the present invention, a first alternative method computes a responsive confidence score without generating a reference table of correspondence.

Also in accordance with the present invention, a second alternative method generates a reference table of correspondence and selects therefrom a responsive confidence score, although without the step of adjusting for monotonicity.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 is a block diagram of the overall process and information flow for an exemplary method of computing a responsive confidence score in accordance with the present invention; and

FIGS. 2 and 3 are probability distribution curves illustrative of variances in AVM valuation as addressed by an aspect of the present invention.

### DETAILED DESCRIPTION OF THE INVENTION

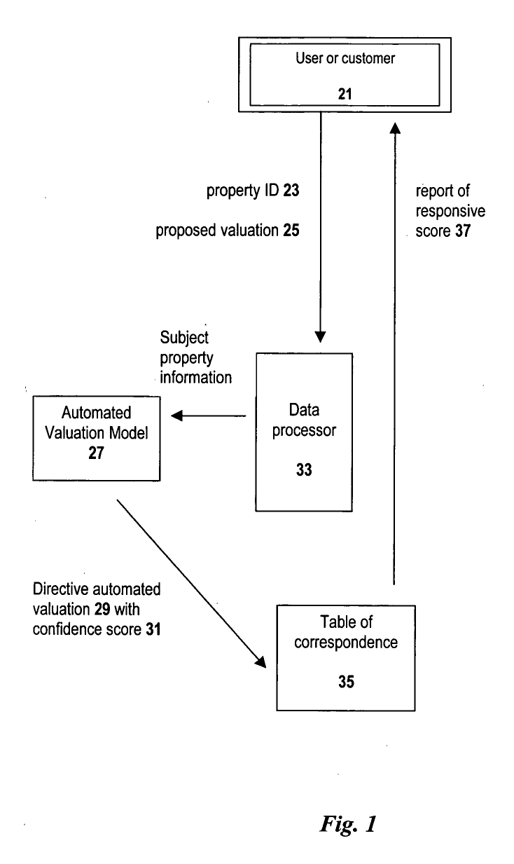

With reference to FIG. 1, in an exemplary method in accordance with the present invention a data processor 33 accepts from the user or customer 21 sufficient information 23 to identify the subject property, such as address or to assessor's property tax identification number. The method also accepts the user's suggested or requested valuation 25 of the subject property.

The method in accordance with the present invention provides a directive AVM valuation 29 using an automated valuation model 27 such as the FARES ValuePoint®4 AVM on the subject property, yielding both a directive valuation and a right-tail-based confidence score 31. This information is used to proceed with the computation of the responsive confidence score 37, but it is not necessary to supply it as output to the user.

The method in accordance with the present invention computes the percentage difference of the suggested, user-supplied valuation from the valuation supplied from the directive AVM. For example, a hypothetical subject property is a single family residence located at 345 Maple Street, Los Angeles, Calif. 99999 for which a user supplies a suggested valuation of $306,000. The method provides a directive VP4 valuation of $300,000 using the AVM, accompanied by a directive confidence score of 85. The method in accordance with the present invention computes the percentage difference as ($306,000-$300,000)/$300,000=2%.

The method in accordance with the present invention consults a two-dimensional reference table of correspondence 35 which associates a responsive confidence score 37 with the directive confidence score and the percentage difference. For example, suppose that for a directive confidence score of 85 and a percentage difference between the directive and suggested valuation of +2%, the table entry in the reference table of correspondence—the table of responsive confidence scores—is 77. The reference table of correspondence, and the key features of its construction, is a component of the process of building a responsive confidence score in the preferred embodiment of the present invention.

The method in accordance with the present invention provides output to the user in a variety of forms, examples of which are given below.
1. The responsive confidence score itself: 77.
2. If desired, the user may also be supplied with the directive AVM valuation and score:
Suggested valuation: $306,000
AVM valuation (directive): $300,000
AVM confidence score at directive value: 85
AVM responsive confidence score: 77.

3. If desired, the user may be supplied with a full table of confidence scores, built from the table of correspondence. The specific numbers supplied here are hypothetical but illustrate what the output might look like.

| Valuation | Confidence score |
|---|---|
| $270,000 | 99 |
| $273,000 | 98 |
| $276,000 | 97 |
| $279,000 | 96 |
| $282,000 | 95 |
| $285,000 | 94 |
| $288,000 | 93 |
| $291,000 | 92 |
| $294,000 | 90 |
| $297,000 | 88 |
| $300,000 (directive) | 85 (directive confidence score) |
| $303,000 | 81 |
| $306,000 (suggested) | 77 (responsive confidence score) |
| $309,000 | 72 |
| $312,000 | 68 |
| $315,000 | 65 |

This table may or may not include the specification that the directive valuation is $300,000.

4. The user may be supplied with a range of possible valuations, with or without their associated confidence scores:

| Valuation | | Confidence score |
|---|---|---|
| Low | $270,000 | 99 |
| Suggested | $306,000 | 77 |
| High | $315,000 | 65 |

It may be noted in options (3) and (4) that the upper and lower limits of valuation are not necessarily symmetric around the directive valuation of $300,000 nor around the suggested valuation of $306,000.

In a preferred embodiment of the method of computing a responsive confidence score in accordance with the present invention, a valuation is never supplied with a confidence score below 65. Rather, the method returns no valuation and no confidence score to the user. Where the confidence score is below 65, the data are simply not reliable enough to deliver or use in financial decisions. Indeed, very low scores may even signal an attempt to defraud the lender. In any event, a loan application under circumstances resulting in a confidence score below 65 should not be mechanically passed on for approval by a responsive model, but instead should be declined with a remark that it is outside what appears to be the conventional range of valuation, and probably should be studied or investigated.

The upper limit of the range of confidence scores is 99, rather than 100. A conference score of 100 suggests absolute certainty, which is not to be expected in real estate valuations.

Table 1 summarizes the flow and dependencies of data for an exemplary method in accordance with the present invention. Each “Object” column entry identifies an object that is given or that is to be derived or computed. To the right of each “Object” column entry is a “Description” column entry describing attributes of the object. To the right thereof is a “Source or Necessary Objects” column entry identifying the source of the object identified in the left column entry or identifying the object or objects that are needed in order to compute or derive it.

TABLE 1

| | | | Source or Necessary |
|---|---|---|---|
| | Object | Description | Objects |
| A | Subject property | Address, parcel number, or other means of | The customer. Alternatively, |
| | identification | identifying the property for which a customer | any entity requesting a |
| | | proposes a valuation. | confidence score. |
| B | Proposed | The customer's proposed (suggested) valuation of | The customer. Alternatively, |
| | (suggested) subject | the subject property, typically given for the purpose of | any entity requesting a |
| | property valuation | supporting a loan application. A number, typically | confidence score. |
| | | denominated in dollars. | |
| C | Directive automated | An estimate of the value of the subject property, | An automated valuation |
| | valuation of the | typically to be used in the manner in which an | model (AVM). In the |
| | subject property | appraisal would be used. A number, typically | preferred embodiment, the |
| | | denominated in dollars. | FARES VP4 AVM. |
| D | Directive confidence | A measure of the certainty or quality of the | An automated valuation |
| | score for the directive | accompanying directive automated valuation of the | model (AVM). In the |
| | automated valuation | subject property, relative to the certainty or quality of | preferred embodiment, the |
| | of the subject | one or more other directive automated valuations (for | FARES VP4 AVM. More |
| | property | example, directive automated valuations of other | generally, an AVM which is |
| | | properties as generated by the same AVM). A | capable of providing an |
| | | number, letter, or grade. In the preferred | ordinally ranked indication of |
| | | embodiment, an integer between 65 and 99. Has an | the relative certainty or |
| | | ordinal ranking, i.e., a higher score indicates a | quality of the accompanying |
| | | greater confidence. | directive automated |
| | | | valuation. |
| E | Data set of sold | A set of objects, each including a property identifier | A database containing sale |
| | properties | and an actual sale price reported as a result of a | price information from, e.g., |
| | | transaction involving the identified property. | public records or other |
| | | | reporting entities. |
| F | AVM valuation | An automated valuation of a property in the data set | An automated valuation |
| | obtainable for a | of sold properties. An estimate of the value of the | model (AVM). For example, |
| | property in the data | property. A number, typically denominated in dollars. | the FARES VP4 AVM. |
| | set of sold properties | Obtained by identifying the property to an AVM and | |
| | | receiving an automated valuation from the AVM. | |
| G | Preliminary multilevel | A measure of the certainty or quality of the | An automated valuation |
| | confidence score for | accompanying automated valuation obtainable for a | model (AVM). For example, |
| | the valuation | property in the data set of sold properties, relative to | the FARES VP4 AVM. |
| | obtainable for a | the certainty or quality of one or more other | Generally, an AVM which is |
| | property in the data | automated valuations (for example, automated | capable of providing an |
| | set of sold properties | valuations of other properties). Has an ordinal | ordinally ranked indication of |
| | | ranking, i.e., a higher score indicates a greater | the relative certainty or |
| | | confidence. | quality of the accompanying |
| | | | directive automated |
| | | | valuation. |
| H | Discrete numerical | A numerical value within the acceptable range of | See G above. |
| | level of the | values of the preliminary multilevel confidence score. | |
| | preliminary multilevel | For example, the number 76 would be a possible | |
| | confidence score | value of the score if the acceptable range was from | |
| | | 65 to 99. | |
| I | Subset of properties | A subset of properties, selected from the data set of | E and G above. |
| | having a particular | sold properties, the criterion of selection being that all | |
| | level of the | properties in the subset received a preliminary | |
| | preliminary multilevel | confidence score equal to the particular value in | |
| | confidence score | question. For example, all properties having the | |
| | | preliminary confidence score of 76. | |
| J | Right-tail directive | For the properties in the subset having this value of | F, G, H and \| above. |
| | confidence score | the preliminary confidence score, e.g., 76, a measure | |
| | associated with a | of the percentage of those properties whose AVM | |
| | numerical level of the | valuation exceeds the same property's actual sale | |
| | preliminary multilevel | price by too much (in the preferred embodiment, 10% | |
| | confidence score for | overvaluation is the criterion based on industry | |
| | a set of sold | usage). For example, if 15% of these properties | |
| | properties. | were overvalued by “too much” the associated | |
| | | directive confidence score would be 85. | |
| K | Proportional | Number reflecting the proportional difference | Derived from the customer's |
| | adjustment to the | between the directive valuation of the subject | proposed valuation (B |
| | valuation of the | property (C above) and the proposed or suggested | above) and the directive |
| | subject property. | valuation of the subject property (B above). A | automated valuation (C |
| | Also known as “a.” | number, e.g., +0.01 where the proposed valuation is | above) that is supplied by |
| | | 1.01 times the directive automated valuation, −0.05 | the AVM. |
| | | where the proposed valuation is 0.95 times the | |
| | | directive automated valuation. | |
| L | Directive variance | The following ratio: | Based on AVM valuation (F |
| | | (Directive AVM valuation - actual sale price)/actual | above) and the sale price of |
| | | sale price | the property (from data set E |
| | | | above). |
| M | Indicator variable | The indicator variable is 1 if, for this property and this | See H and L above. |
| | associated with a | value of “a,” the following statement is true: | |
| | particular property | directive variance >[(1.10)/(1 + a)] − 1 | |
| | and with a particular | and 0 otherwise. | |
| | value of “a” | | |
| N | Mean of the indicator | Sum of the indicator variables associated with all the | M above, computed for the |
| | variable for a set of | properties in the data set at this particular value of “a” | set of properties having the |
| | properties associated | and this particular directive confidence score, divided | values in question for “a” |
| | with a particular value | by the number of those properties. | and the directive confidence |
| | of “a” and a particular | | score. |
| | directive confidence | | |
| | score. | | |
| O | Responsive | A measure of the risk associated with the user's | N above. |
| | confidence score for | proposed valuation of the subject property. A | |
| | the given property | number between 65 and 99, usually an integer. | |
| | and proposed | | |
| | valuation | | |

### The Multi-Stage Construction of a Confidence Score with Right-Tail Architecture

The method in accordance with the present invention, like that of FARES' VP4 AVM, uses a right tail architecture. The methodology used by FARES in building both its directive and its responsive “right-tail” confidence scores is significantly more advanced than what is used by traditional confidence scoring algorithms. Although the VP4 AVM is used in the preferred embodiment, the present invention may employ any AVM which has a right tail architecture. The right tail architecture has the advantage of specifically pointing out the danger of lender exposure in the case of default. It also lends itself in a mathematically natural way to the construction of advanced products such as a responsive confidence score.

The method in accordance with the present invention constructs a conventional numerical many-leveled confidence score for each valuation obtainable for each of an exhaustive data set of sold properties. Initially, a valuation is computed using an AVM for each property in the data set of sold properties. A preliminary “conventional” conference score is then assigned to each valuation. This preliminary confidence score (or “value score”) is called “conventional” in that it ranks and judges each property according to the factors which make for improved AVM quality, i.e., the extent and reliability of the underlying database of recorded sold property information; the number, recency of sale, homogeneity, and similarity to a subject property of the group of “comps” that would be used in valuing a subject property; the accuracy and relative importance of any city-, county-, or state-level price appreciation indices that may be used in the valuation process, and other relevant factors and considerations. The preliminary score is built by a mathematical algorithm from the merits and importance of all factors involved in the valuation.

This score is called “numerical” because it appears in the form of a number, typically from 0 to 100. At this stage the numbers are not necessarily equal to any standard deviation, median absolute variance, or probability of unacceptable valuation. However, they do have an ordinal ranking in the sense that a higher score indicates a greater confidence in the valuation and an expectation that its quality will be better.

This score is called “many-leveled” because it must have at least as many separate and discrete levels or “tranches” as the directive or responsive score will have. For example, if possible confidence scores (responsive or directive) are envisioned from 65 through 99, a total of 35 levels, then the preliminary confidence score must have at least 35 discrete levels. A larger quantity of levels is definitely preferable.

The term “obtainable” is used because no AVM can assign a valuation for all properties in all locations in all circumstances. For example, sometimes in a desert area there are no recent comparable sales for many miles. Some properties appear in a database without addresses or characteristics, due to absences in the underlying database. However, a good AVM can value the great majority of properties that it studies, usually over ninety percent of them.

The term “exhaustive” is important and essential. Most statistical studies and products in the real estate information industry are built using samples of a few hundred or a few thousand properties. In contrast, the present methodology looks at exhaustive data sets, such as the set of all sold residential properties in several hundred counties of the United States with their sale deeds recorded during a set period of time such as the year 2002 or a group of months in the year 2003. In rural areas the time window may be extended according to a set of rules to include a number of sales sufficiently large to permit analysis. The important point is to gather in all the sold properties in a certain “net” rather than a selected small group of those properties.

For each discrete numerical level of this preliminary confidence score, the method in accordance with the present invention computes the percentage of AVM valuations that were more than ten percent above the actual sale price. This computation then leads to the right-tail directive confidence score associated with that preliminary confidence score. For example, if there were 6,000 sold and valued properties that had a preliminary score of 75, and 1200 of these valuations were more than 10% above the actual sale prices of those properties, then since 1200/6000=0.20, or 20%, the valuations for the properties in this set are assigned a directive confidence score of 80. This directive confidence score of 80 need not be equal to the original preliminary score of 75. Also, some doubling up and spreading out is at least possible. It may be that preliminary scores of both 75 and 76 are assigned to directive confidence scores of 80, or it may be that the “spread” of scores widens from 75-76 to 80-82, in the case where a preliminary score of 76 is assigned to a directive confidence score of 82. Because of the possibility of spreading out or contracting or doubling, it is important to use a preliminary confidence score with many discrete levels—at least as many as are envisioned for the directive and responsive confidence scores themselves.

One easy way to compute these right-tail scores is to define an indicator variable for the entire data set including all score levels which is 1 if the valuation is ten percent or more too high, and 0 if it is not. The mean of this indicator variable is exactly the fraction of valuations which are ten percent (10%) or more too high, whether this mean is calculated on the entire data set or on its subsets such as the preliminary confidence score tranches.

Individual properties are either well-valued or they are not. That is to say, individual valuations are correct or they are not. They are either too high or they are not. Default and loss either occur or they do not. However, it is fair to say that the directive confidence score of 80 does in fact measure safety to a lender, in the sense that it is known that only 20% of valuations with this directive confidence score were in fact ten percent or more above the actual market sale price.

It is important that the original preliminary confidence score be constructed in a natural and reasonable manner. While such a score does not demand a methodology and algorithm specified and restricted down to its small details, it should reasonably correspond to the strength and reliability of the valuation, so that higher preliminary scores approximately correspond to stronger valuations built upon stronger data sets. Thus, a discrete level of the preliminary score represents a reasonably coherent level or “commonality” of valuation strength, although the member properties may be geographically distributed over the entire nation.

It is preferable that an exhaustive data set, or a set as nearly exhaustive as possible, be used. In such a case, it is legitimate to say that a randomly chosen valuation having a directive confidence score of 80 will have a twenty percent probability of being 10% or more above the market sale price. This is because, out of the total underlying population of properties with a directive confidence score of 80, twenty percent of these properties actually do have AVM valuations ten percent or more above their sale prices. If a customer had valued all the properties in this “80” level, he or she would find that twenty percent of them had valuations that were ten percent or more too high. This outcome is in harmony with the very mathematical concept of probability. It is legitimate to say that a directive confidence score of 80 does represent that the probability of a ten-percent-or-more-too-high valuation is 20%, and that a directive confidence score of 85 represents that probability of a dangerous overvaluation as 15%, and so on.

In contrast, such statements would be tenuous if a small sample of a few hundred or a few thousand properties were to be used. It would not necessarily follow that the percentage of risky overvaluations in set of the sample was equal to the percentage of such overvaluations in the entire national set of sold properties. Logically there would exist a gap in passing from a small sample to the underlying population of properties—and mathematically the percentages of overvaluations, and hence the correct confidence scores, would likely differ between sample and population, thus rendering the entire product of questionable use. For this reason, the AVM used with the present invention should use confidence scores built on large populations of sales records.

The preliminary confidence score, from which the directive confidence score is built, must be well designed. Otherwise, it might be possible in a set of properties with a directive confidence score of 80, representing a 20% probability of risky overvaluation, that 30% those properties on the East Coast were so overvalued, while only 10% of those properties on the West Coast were overvalued. In such a case, one could not rely on the overall directive confidence score unless its criteria and algorithms are reasonable, intuitive and sensible. In order to define the original preliminary confidence score according to criteria and algorithms that are reasonable, intuitive, and sensible, valuations built on sets of the same strength should have reasonably similar probabilities of risky overvaluation, regardless of what part of the country they are in, or what square footage they may have, etc. It is generally the case that a well-designed preliminary confidence score will avoid serious problems of this type, as the strengths and weaknesses of the data and valuations in different geographic areas and different property types or price levels or sizes of residence will already have been reflected in the preliminary confidence score itself.

It will be assumed hereinafter that each property in an exhaustive, or nearly exhaustive, data set has been assigned a directive valuation and directive confidence score, and hence has been classified as a member of a discrete level or tranche consisting of those properties with valuations having the same directive confidence score level.

As has been stated earlier, the AVM used in the preferred embodiment of the invention does not return directive confidence scores under a predetermined level of 65 (or valuations with such scores), in order to ensure the trustworthiness of valuations. However, the lowest level of confidence scores may be adjusted to any predetermined level in the preferred embodiment.

Thus, the exhaustive data set can be divided into:
The subset of properties with directive confidence score of 65
The subset of properties with directive confidence score of 66
The subset of properties with directive confidence score of 67 . . . and so on up to a directive confidence score of 99.

The method in accordance with the present invention builds and uses a reference table of correspondence to derive a responsive confidence score. The construction of the reference table will be described.

It is assumed that each property has (1) a customer-supplied suggested valuation; (2) an AVM-supplied directive valuation, thus determining (3) the percentage difference between the suggested and directive valuations; and (4) an AVM-supplied directive confidence score. An algorithm is then used to compute a responsive confidence score from the components (3) and (4). The algorithm is derived in accordance with the procedure set forth hereinafter.

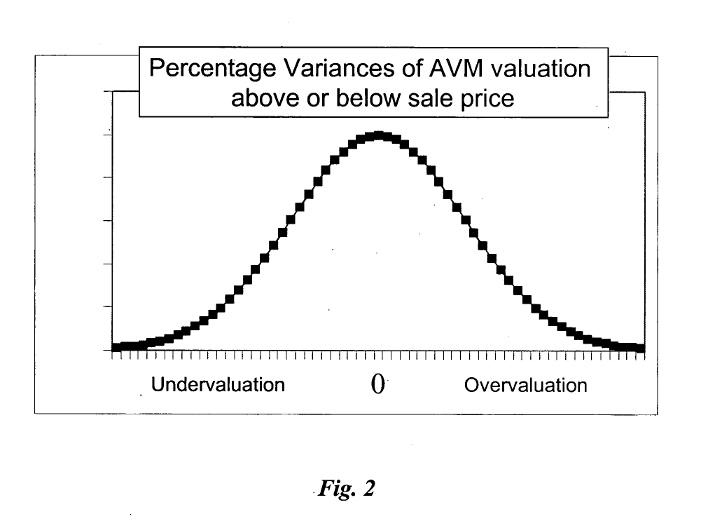

In each set of valuations, there is a percentage variance of directive AVM valuation above or below the actual sale price. For a well-designed AVM, most of these variances will be near zero. Roughly half of them will be positive (valuation above sale price) and the other half will be negative (valuation below sale price). Although most of the variances will be small (AVM valuation close to actual sale price), a few of them will be quite a bit higher or lower than the sale price. In the distribution curve of FIG. 2, those variances will fall into the right tail and left tail of the distribution. For purposes of illustration, the distribution of variances will approximately follow a normal distribution or “bell curve” even though the actual curve may look modestly different. If the AVM performs well, the tails will be small and not extend very far to the extreme right or left. If the performance is inferior, large right or left tails may occur.

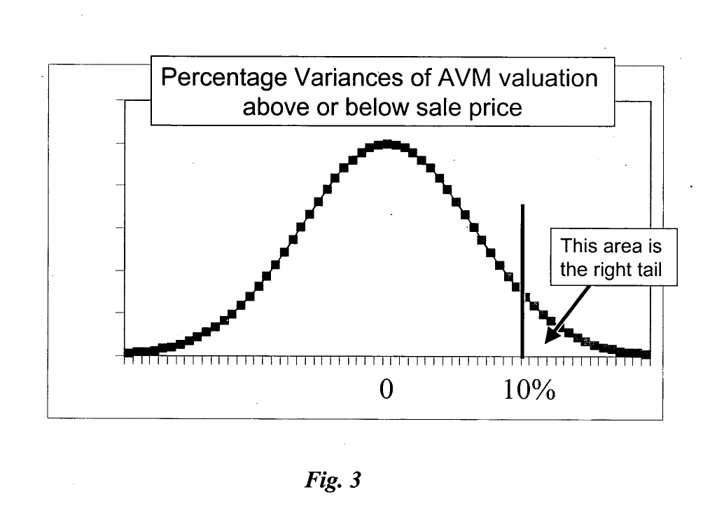

The “zone of exposure,” representing those properties where the directive AVM valuation is more than 10% above the actual sale price, is seen as the right tail in the distribution curve of FIG. 3. The right tail, the zone of exposure, is represented by the area underneath the curve, to the right of the vertical line representing a 10% overvaluation. The right tail associated with a larger overvaluation (say 15% or more) will be smaller. The right tail associated with a smaller overvaluation (say 5% or more) will be larger.

Generally, a better AVM will have a smaller right tail that exceeds a fixed overvaluation level of 10%. Generally, an inferior AVM will produce a larger right tail that goes beyond a fixed overvaluation level of 10%, and thus a greater risk of exposure to danger in the case of a loan default, because its valuations are less frequently close to the sale price (or “true value”) and more frequently ten percent or more above it.

FIGS. 2 and 3 show only what happens in the case of the directive valuation and the directive confidence score. The user-supplied, suggested valuation may be either higher or lower than the conventional directive AVM valuation. The mathematical interrelationships between the directive valuation, the suggested valuation, and the corresponding confidence scores will now be described.

The method in accordance with the present invention is explained with reference to mathematical equations. Let “a” be the proportional adjustment to the valuation, i.e., the proportional difference between the existing directive valuation and the valuation requested by the customer. In the examples used here, “a” will be given as a decimal, often expressed in percents. In cases where the suggested valuation leads to “a” not being an exact multiple of 0.01, it is preferable to round “a” upwards to the nearest multiple of 0.01 in the interest of conservatism.

If the directive valuation of the property is $300,000, and the customer is interested in a valuation of $306,000, then a=0.02.

If the directive valuation of the property is $300,000, and the customer is interested in a valuation of $291,000, then a=−0.03.

What defines a right tail error of excessive valuation? A right tail error occurs when:
Directive AVM valuation>(1.10)*true value.

Here “true value” is used to indicate the sale price or any other definition of actual market value, in contrast to any error that might be made. In order to compute the algebraic relationship between the requested or suggested valuation and the existing directive valuation, let “a” be the proportional adjustment: then the suggested (or requested) valuation is equal to (1+a)*Directive AVM valuation.

Using the same definition as was used for the directive valuation, a right tail error for the suggested valuation means
Suggested valuation>(1.10)*true value.

By definition, this is the same as:
(1+a)*Directive AVM valuation>(1.10)*true value.

Performing basic algebraic operations, the following is derived:
Directive AVM valuation>[(1.10)*true value]/(1+a)

Thus,
Directive AVM valuation/true value>(1.10)/(1+a).

Thence,
(Directive AVM valuation/true value)−1>[(1.10)/(1+a)]−1.

This is equivalent, by definition, to,
Directive AVM variance>[(1.10)/(1+a)]−1.

We will illustrate the functioning of this equation using several examples.

### EXAMPLES

If a=0.10 then a right tail error is when the directive valuation variance>0.

If the suggested valuation is 10% above the directive valuation, then this suggested valuation will be 10% too high in exactly the same cases when the directive valuation is 0% or more too high.

If a=0.05 then a right tail error is when directive AVM variance exceeds [(1.10)/(1.05)]−1, about 4.76%.

If the suggested valuation is 5% above the directive valuation, there will be a larger right tail than if we used the directive valuation. The right tail will be bigger and the confidence score lower.

If a=−0.05 then a right tail error is when AVM variance exceeds [(1.10)/(0.95)]−1, about 15.97%.

If the suggested valuation is 5% below the directive valuation there will be a smaller right tail than if we used the directive valuation. Only larger errors made by the AVM will count as right tail errors when there is a 5% cushion. The confidence score will be higher.

The method in accordance with the present invention builds a reference table of correspondence, a process which entails defining and using new indicator variables.

The actual probabilities of making these right tail overvaluation errors, whether the tail be larger or smaller than the original 10%, are the foundational numbers used in building the responsive confidence scores in the reference table.

If the distribution of variances of the original directive valuations always followed a perfect theoretical normal bell curve, these probabilities could be calculated mathematically from standard tables of the normal distribution function.

However, with actual real-world data sets, the literal, actual distributions of variances are only approximately normal. The curve may be slightly irregular, slightly off-center, or slightly asymmetric with one tail formed differently from the other. Furthermore, these distributions of variances may and often do vary modestly in shape and curve from one directive confidence score subset tranche to another.

Thus, it is preferable to calculate these modified right tail probabilities empirically using a data set on the order of over 200,000 sold properties with existing directive valuations and known sale prices. Here the valuation variances were known for each property, and it was known for each property if a right tail overvaluation error was made or not. Twenty-one adjusted right-tail indicator variables (with values either 1 or 0) were defined and calculated. The following examples will illustrate how this was done.

The +5% adjustment indicator variable associated with a particular property is 1 if the suggested valuation variance>10%, which means the directive AVM variance>4.76%. Otherwise, the +5% adjustment indicator variable is zero.

The −5% adjustment indicator variable associated with a particular property is 1 if the suggested valuation variance >10%, which means the directive AVM variance >15.97%. Otherwise, the −5% adjustment indicator variable is zero.

The 0% indicator variable (for no changes) associated with a particular property is 1 if the suggested valuation variance>10%, which means the directive AVM variance>10%. Otherwise, the 0% indicator variable is zero (no changes here, since in this case the suggested valuation is identical with the directive valuation).

Twenty-one such indicator variables were computed, representing adjustments from −10% to 0% to +10%. Here “adjustment” refers to “a,” the percentage difference between the suggested or requested valuation and the existing directive AVM valuation.

The mean of each indicator variable represents the probability of making a 10% or higher right tail overvaluation error, using the suggested (requested) valuation, where the “adjustment” is the “a,” the percentage difference between the suggested valuation and the existing directive valuation.

These means or probabilities were computed separately and distinctly, for each confidence score level (tranche) that the directive valuation delivers on a directive basis, and for each level of adjustment from −10% to +10%.

That is, the means of each of the 21 indicator variables were computed separately for each subset of the data as defined by the existing AVM directive confidence score levels.

In principle, this could be done for any confidence level and any size of adjustment. In these examples in the preferred embodiment 10% is used as the maximum adjustment up or down. Because still higher valuations have prohibitively low confidence scores, a valuation with a confidence score of 30, representing a 70% probability that it is 10% or more too high, has relatively little credibility. Similarly, very low valuations, while easy to “pass,” fall outside the main body of valuations, thus raising “distribution tail” difficulties. Furthermore, the upper limit of confidence scores is set at 99 because a score of 100 would suggest absolute certainty, which is not to be expected in the world of real estate.

Table 2 below shows the actual means (probabilities) for some confidence score levels and positive valuation adjustments for a 2003 test set. As would be expected, the numbers get larger as the entries move to the right, because higher valuations carry with them the greater probability or risk that they are too high.

TABLE 2

| Directive | | PROBABILITIES OF RIGHT TAIL ERROR (10% OR MORE) | | | | | |
|---|---|---|---|---|---|---|---|
| Confidence | N of | ADJUSTMENT | ADJUSTMENT | ADJUSTMENT | ADJUSTMENT | ADJUSTMENT | ADJUSTMENT |
| Score | Cases | no change | up 1 pct | up 2 pct | up 3 pct | up 4 pct | up 5 pct |
| 70 | 5,834 | 0.2940 | 0.3135 | 0.3346 | 0.3546 | 0.3757 | 0.3968 |
| 71 | 5,069 | 0.2383 | 0.2549 | 0.2750 | 0.2955 | 0.3158 | 0.3354 |
| 72 | 8,723 | 0.2736 | 0.2931 | 0.3134 | 0.3323 | 0.3535 | 0.3743 |
| 73 | 4,183 | 0.2307 | 0.2462 | 0.2637 | 0.2804 | 0.2969 | 0.3148 |
| 74 | 11,852 | 0.2531 | 0.2746 | 0.2962 | 0.3170 | 0.3374 | 0.3597 |
| 75 | 9,442 | 0.2415 | 0.2632 | 0.2848 | 0.3058 | 0.3277 | 0.3519 |
| 76 | 5,137 | 0.2309 | 0.2529 | 0.2731 | 0.2965 | 0.3175 | 0.3428 |
| 77 | 5,737 | 0.2283 | 0.2489 | 0.2705 | 0.2899 | 0.3139 | 0.3331 |
| 78 | 5,958 | 0.2187 | 0.2395 | 0.2586 | 0.2776 | 0.2994 | 0.3244 |
| 79 | 6,349 | 0.2089 | 0.2289 | 0.2481 | 0.2678 | 0.2912 | 0.3133 |
| 80 | 6,743 | 0.1926 | 0.2112 | 0.2312 | 0.2537 | 0.2766 | 0.3028 |

Similarly, as shown in Table 3 below, when adjustments are negative (the requested valuation is lower than the directive valuation) the probabilities of dangerous overvaluation become smaller.

TABLE 3

| Directive | | | | | | | |
|---|---|---|---|---|---|---|---|
| Confidence | N of | ADJUSTMENT | ADJUSTMENT | ADJUSTMENT | ADJUSTMENT | ADJUSTMENT | ADJUSTMENT |
| Score | Cases | no change | down 1 pct | down 2 pct | down 3 pct | down 4 pct | down 5 pct |
| 70 | 5,834 | 0.2940 | 0.2767 | 0.2611 | 0.2396 | 0.2254 | 0.2096 |
| 71 | 5,069 | 0.2383 | 0.2233 | 0.2105 | 0.1933 | 0.1803 | 0.1693 |
| 72 | 8,723 | 0.2736 | 0.2519 | 0.2346 | 0.2188 | 0.2023 | 0.1859 |
| 73 | 4,183 | 0.2307 | 0.2125 | 0.1958 | 0.1826 | 0.1690 | 0.1575 |
| 74 | 11,852 | 0.2531 | 0.2334 | 0.2161 | 0.2002 | 0.1865 | 0.1715 |
| 75 | 9,442 | 0.2415 | 0.2217 | 0.2049 | 0.1884 | 0.1740 | 0.1611 |
| 76 | 5,137 | 0.2309 | 0.2097 | 0.1912 | 0.1729 | 0.1563 | 0.1421 |
| 77 | 5,737 | 0.2283 | 0.2095 | 0.1881 | 0.1708 | 0.1567 | 0.1414 |
| 78 | 5,958 | 0.2187 | 0.2011 | 0.1813 | 0.1648 | 0.1490 | 0.1371 |
| 79 | 6,349 | 0.2089 | 0.1914 | 0.1750 | 0.1586 | 0.1451 | 0.1304 |
| 80 | 6,743 | 0.1926 | 0.1753 | 0.1609 | 0.1470 | 0.1305 | 0.1175 |

Building a reference table of correspondence is further explained with reference to the mathematical property of monotonicity. It is to be expected that the probabilities in these tables will be monotonic (trending steadily up or down) in two ways:
1. As the adjustment increases, it is easier to value a property too high—so the right tail gets bigger and the probability increases. The number in the table will be higher. In the table, this is horizontal monotonicity. If an adjustment were negative and became more and more negative, the probability of a right-tail error would decrease and the number in the table will be lower. This is also an example of horizontal monotonicity.
2. At higher and higher levels of the standard directive confidence score, the standard right tail gets smaller. Therefore, any adjusted right tail would also be smaller and the probability decreases. In the table, this is vertical monotonicity. In other words, the numbers should get higher going across in the case of larger positive adjustments and lower going down to higher standard directive confidence levels.

Conversely, in the case of larger negative adjustments, the numbers should get lower going across, but also lower going down within the table.

In the actual real-world calculations, both directions of monotonicity were observed in almost all possible cases. The exceptions arose from the irregularities found in any actual real estate data set, irregularities and variations in sale price, and the fact that the directive score was itself calculated from a previous preliminary confidence score. But these exceptions occurred only infrequently, as exceptions rather than a general condition. The tables were almost completely characterized by monotonicity in both directions.

The method in accordance with the present invention builds a table of correspondence in order to progress from probabilities to scores. It is simple to convert these probabilities into an unmodified table of responsive confidence scores.

In the Tables 2 and 3 above, a directive confidence score of 70 and a positive 1% adjustment leads to an indicator variable mean of 0.3135, representing a probability of a 10% or greater overvaluation of 0.3135—and hence the probability of not making such a right-tail error would be 1 minus 0.3135, or 0.6865.

Multiplying by 100 to move towards a scale of 0 to 100 yields the number 68.65, which rounds down to a responsive confidence score of 68.

These roundings are done downwards, in the interest of conservatism. It is better to choose the side of caution when delivering a responsive confidence score to a customer, especially since this product is a derivation from a previously existing directive valuation and confidence score.

Examples of these unmodified reference tables appear below in Tables 4 and 5.

TABLE 4

| Directive | | UNMODIFIED 2003 RESPONSIVE CONFIDENCE SCORE | | | | | |
|---|---|---|---|---|---|---|---|
| Confidence | N of | ADJUSTMENT | ADJUSTMENT | ADJUSTMENT | ADJUSTMENT | ADJUSTMENT | ADJUSTMENT |
| Score | Cases | no change | up 1 pct | up 2 pct | up 3 pct | up 4 pct | up 5 pct |
| 70 | 5,834 | 70 | 68 | 66 | 64 | 62 | 60 |
| 71 | 5,069 | 76 | 74 | 72 | 70 | 68 | 66 |
| 72 | 8,723 | 72 | 70 | 68 | 66 | 64 | 62 |
| 73 | 4,183 | 76 | 75 | 73 | 71 | 70 | 68 |
| 74 | 11,852 | 74 | 72 | 70 | 68 | 66 | 64 |
| 75 | 9,442 | 75 | 73 | 71 | 69 | 67 | 64 |
| 76 | 5,137 | 76 | 74 | 72 | 70 | 68 | 65 |
| 77 | 5,737 | 77 | 75 | 72 | 71 | 68 | 66 |
| 78 | 5,958 | 78 | 76 | 74 | 72 | 70 | 67 |
| 79 | 6,349 | 79 | 77 | 75 | 73 | 70 | 68 |
| 80 | 6,743 | 80 | 78 | 76 | 74 | 72 | 69 |

TABLE 5

| Directive | | | | | | |
|---|---|---|---|---|---|---|
| Confidence | N of | ADJUSTMENT | ADJUSTMENT | ADJUSTMENT | ADJUSTMENT | ADJUSTMENT |
| Score | Cases | down 1 pct | down 2 pct | down 3 pct | down 4 pct | down 5 pct |
| 70 | 5,834 | 72 | 73 | 76 | 77 | 79 |
| 71 | 5,069 | 77 | 78 | 80 | 81 | 83 |
| 72 | 8,723 | 74 | 76 | 78 | 79 | 81 |
| 73 | 4,183 | 78 | 80 | 81 | 83 | 84 |
| 74 | 11,852 | 76 | 78 | 79 | 81 | 82 |
| 75 | 9,442 | 77 | 79 | 81 | 82 | 83 |
| 76 | 5,137 | 79 | 80 | 82 | 84 | 85 |
| 77 | 5,737 | 79 | 81 | 82 | 84 | 85 |
| 78 | 5,958 | 79 | 81 | 83 | 85 | 86 |
| 79 | 6,349 | 80 | 82 | 84 | 85 | 86 |
| 80 | 6,743 | 82 | 83 | 85 | 86 | 88 |

Note that the monotonicity is reversed because of the subtraction “1minus” the process, so that the numbers (for positive adjustments) get lower going across Table 4, and higher going down the columns, while for negative adjustments they get higher going across Table 5, and also higher going down the columns.

In accordance with the present invention, the reference table of correspondence is modified for monotonicity.

Ideally a reference table of correspondence should exhibit monotonicity in two directions, and this is usually but not always the case. In order for the table to be monotonic, it is appropriate to adjust a few of the entries in the table of correspondence.

For example, in Table 6 below, which is a subset of Table 4, all rows of the table exhibit horizontal monotonicity. However, occasionally there are departures from vertical monotonicity.

TABLE 6

| Directive | | UNMODIFIED 2003 RESPONSIVE CONFIDENCE SCORE | | | | | |
|---|---|---|---|---|---|---|---|
| Confidence | N of | ADJUSTMENT | ADJUSTMENT | ADJUSTMENT | ADJUSTMENT | ADJUSTMENT | ADJUSTMENT |
| Score | Cases | no change | up 1 pct | up 2 pct | up 3 pct | up 4 pct | up 5 pct |
| 70 | 5,834 | 70 | 68 | 66 | 64 | 62 | 60 |
| 71 | 5,069 | 76 | 74 | 72 | 70 | 68 | 66 |
| 72 | 8,723 | 72 | 70 | 68 | 66 | 64 | 62 |
| 73 | 4,183 | 76 | 75 | 73 | 71 | 70 | 68 |
| 74 | 11,852 | 74 | 72 | 70 | 68 | 66 | 64 |

While all rows exhibit horizontal monotonicity (the numbers get lower going from left to right), there is an approximate, but not exact, vertical monotonicity. The numbers should get larger going down Table 6, and in a general way they do. But, for example, the column “up 1 pct” has entries
68, 74, 70, 75, 72.

The general trend is upward but it is not absolutely monotonic. It is appropriate to modify the numbers empirically to produce monotonicity, preferring the direction of conservatism, to protect the customer and provide a surer estimate of confidence. A reasonable set of modifications would be to change the column to
68, 69, 70, 71, 72.

Numbers that have been altered are shown above in bold-face. The column now possesses vertical monotonicity.

It is noteworthy that the “Adjustment no change” column does not agree with the directive confidence score. This is because the original directive confidence score was previously adjusted for monotonicity. Therefore, the “Adjustment no change” column should really read 70, 71, 72, 73, 74.

With appropriate adjustments such as these, a reference table of correspondence which is monotonic and consistent in the vertical direction as well as the horizontal direction may be readily produced.

The method in accordance with the present invention builds a table of correspondence, provided that there are minimum acceptable entries.

As has been stated, in the preferred embodiment valuations with a directive confidence score below 65 are not returned. It has been determined that a confidence score below 65 does not exhibit a minimum level of confidence in the valuation and the data set underlying it.

In the preferred embodiment, the same minimum level of confidence is applied in computing responsive confidence scores. Thus, the entries in the reference table of correspondence (modified for monotonicity) that are below 65 should simply be blanked or “nulled.” Because, as stated above, in the preferred embodiment a valuation or directive confidence score below 65 is not returned, so also a responsive confidence score for a requested or suggested valuation below 65 is not returned. Since an unreasonably low confidence score is excessively prone to overvaluation error and therefore possible exposure, in the preferred embodiment all entries (directive or responsive) under 65 will be removed from the reference table of correspondence.

The reference table computed in accordance with the present invention should be validated to avoid the danger that the entire project and its responsive confidence score was built around the peculiar characteristics of a particular set of data, large though that data set might be.

In the initial construction of the reference table, a data set was used which consisted of a large and exhaustive set of all sold residential properties throughout several hundred counties across the United States, with sales recorded during a fixed time period in 2003. In the case of rural areas with few sales, the time period was extended into the past to insure accuracy in the validation process.

Then, to validate the reference table, the rules developed for this 2003 set were applied to a corresponding 2002 set. A table of correspondence was built for the 2002 set and adjusted for monotonicity.

Then the two tables were compared for validation. Random and small differences are to be expected due to the process of rounding numbers, and due to differences in the data sets and modest differences in the curve and shape of the distributions of variances. But the entries in the reference table of correspondence for the 2002 set were found to be very close to those in the table generated for the 2003 set, thereby validating the methodology and the reference table.

It is desirable to arrive at a single reference table of correspondence which is legitimately applicable to the data sets of both years. This would serve to authenticate the model as applicable not only to a single data set, large though it may be, but to the general market situation as studied over a period of two years.

The following rules were applied to arrive at a reference table of correspondence that was applicable to both data sets:

Where the two yearly entries differed by only one point (one percentage point), the 2003 numbers were generally preferred. As stated, such differences may be due to rounding only.

Where the two entries differed by two percent or more, a composite entry was derived by starting with the 2003 number and, if necessary, adjusting the number, but preferring the downward direction of conservatism, with as few as possible and as small as possible upward revisions. This number was adjusted with a goal of making it no more than 1 percent more generous than (above) either of the two yearly numbers and no more than 3 percent more conservative than (below) either of the two numbers.

The resulting composite reference table of correspondence was checked for monotonicity, and all entries below 65 were converted to blank cells.

Sample pieces of the modified table of correspondence appear below in Tables 7 and 8. The numbers are modestly, but not strikingly, different from the numbers in the unmodified table.

TABLE 7

| Directive | | MODIFIED 2003 RESPONSIVE CONFIDENCE SCORE | | | | | |
|---|---|---|---|---|---|---|---|
| Confidence | N of | ADJUSTMENT | ADJUSTMENT | ADJUSTMENT | ADJUSTMENT | ADJUSTMENT | ADJUSTMENT |
| Score | Cases | no change | up 1 pct | up 2 pct | up 3 pct | up 4 pct | up 5 pct |
| 70 | 5,834 | 70 | 68 | 66 | | | |
| 71 | 5,069 | 71 | 69 | 67 | 65 | | |
| 72 | 8,723 | 72 | 70 | 68 | 66 | | |
| 73 | 4,183 | 73 | 71 | 70 | 67 | 65 | |
| 74 | 11,852 | 74 | 72 | 70 | 68 | 66 | |
| 75 | 9,442 | 75 | 73 | 71 | 69 | 67 | |
| 76 | 5,137 | 76 | 74 | 72 | 70 | 68 | 65 |
| 77 | 5,737 | 77 | 75 | 72 | 71 | 68 | 66 |
| 78 | 5,958 | 78 | 76 | 74 | 72 | 70 | 67 |
| 79 | 6,349 | 79 | 77 | 75 | 73 | 70 | 68 |
| 80 | 6,743 | 80 | 78 | 76 | 74 | 72 | 69 |

TABLE 8

| Directive | | | | | | |
|---|---|---|---|---|---|---|
| Confidence | N of | ADJUSTMENT | ADJUSTMENT | ADJUSTMENT | ADJUSTMENT | ADJUSTMENT |
| Score | Cases | down 1 pct | down 2 pct | down 3 pct | down 4 pct | down 5 pct |
| 70 | 5,834 | 72 | 73 | 76 | 77 | 79 |
| 71 | 5,069 | 73 | 75 | 77 | 78 | 80 |
| 72 | 8,723 | 74 | 76 | 78 | 79 | 81 |
| 73 | 4,183 | 75 | 77 | 79 | 80 | 81 |
| 74 | 11,852 | 76 | 78 | 79 | 81 | 82 |
| 75 | 9,442 | 77 | 79 | 81 | 82 | 83 |
| 76 | 5,137 | 78 | 80 | 82 | 84 | 85 |
| 77 | 5,737 | 79 | 81 | 82 | 84 | 85 |
| 78 | 5,958 | 79 | 81 | 83 | 85 | 86 |
| 79 | 6,349 | 80 | 82 | 84 | 85 | 86 |
| 80 | 6,743 | 82 | 83 | 85 | 86 | 88 |

These samples are only a small part of the total table of correspondence, but they should serve as illustrations of the process of its development.

Subsequently, the table of correspondence was also “forward validated” as well as “backward validated,” introducing a third exhaustive data set with sales recorded in a predetermined time period during late 2003. None of the numbers was more than 1 percent higher than its corresponding number in the late 2003 table, and almost all of the entries were from 0 to 3 percent more conservative, which is reasonable because the existing table of correspondence was conservatively built using two data sets, one from earlier in 2003 and one from 2002. A few of the entries corresponding to large adjustments to valuations at high confidence scores were as much as 5 percent more conservative in the early 2003 table than their corresponding entries in the late 2003 table of correspondence. However, because these entries represent the end or extremity of the range of function of the product, the conservative numbers were retained rather than making them more generous to reflect their equivalents in late 2003. Another reason for this caution was because the late 2003 validation set was smaller in size than the 2002 or early 2003 data sets. Thus, the reference table exhibited valid entries when tested for forward validation.

The numbers in the tables above may thus serve as samples to illustrate the elements of the process. In alternative embodiments of the present invention, using future validation sets, the specific numbers in the cells of the table of correspondence may be modified. However, the method of the present invention is the same.

Thus, the preferred embodiment of the present invention provides a reference table of correspondence, using the empirically calculated right-tail probabilities at various levels of valuation adjustment. The right-tail methodology may be consistently extended from a directive confidence score to a responsive confidence score with a larger or smaller tail.

In contrast, the confidence scoring methodologies used by other automated valuation models do not lend themselves readily or consistently to the construction of a responsive confidence score.

For example, if a valuation is assigned a numerical confidence score that represents its accuracy (standard deviation of variances, or perhaps the mean or median absolute value of the variances, or some other statistical measure of central tendency), this method may be useful in a directive confidence score, but does not lend itself well or consistently to building a responsive confidence score. If a set of suggested valuations were all 5 percent above their corresponding directive valuations, the distribution of variances would be shifted 5 percent to the right (higher)—but its standard deviation would remain exactly the same. It might be possible to calculate, theoretically or empirically, a new standard deviation, or mean and median absolute variance, based on the variances of the suggested valuations from the sale prices or other measure of true value. But that result would be prone to bias and error, because it would be computing the central tendency of a distribution that was known to be off-center, often substantially so. While some complicated and rather unnatural algorithm might be designed, it would not have the mathematical elegance and consistency obtained by using the right-tail methodology. Thus, a numerical measure of central tendency does not lend itself well to the construction of a responsive confidence score.

The present invention also provides a substantial benefit over valuation methods which provide letter grades. In such letter grade valuation procedures, a certain directive valuation is assigned a directive confidence letter grade such as “A” or “B.” This type of confidence scoring does not provide a sufficient number of discrete levels to provide a useful responsive confidence score or to indicate how close a suggested valuation is to the directive valuation. For example, if a directive valuation of $300,000 received an “A,” and a suggested valuation of $306,000 also received an “A,” a user would not know that the second valuation is more prone to exposure than the first was or would have been. Presumably at some level of higher valuation a lower grade would be given. If a suggested valuation of $315,000 received a “B,” it is not clear at what point the change would be made from “A” to “B,” and why. The grade of “B” would rate all “B” valuations equally, across a wide range of probability of exposure, until at some point the grade was abruptly demoted to “C.” This methodology is inferior to the right-tail methodology in building a responsive confidence score, even if a definition of “A,” “B,” and other grades were given.

The present invention is also superior to methods which assign a directive number grade such as 75, that is merely a qualitative description of quality or accuracy, presumably a monotonic description. Such methods do not specifically and numerically indicate any quantitative measure. Although higher suggested valuations can be assigned lower grades to avoid much of the discontinuity and abruptness of the preceding paragraph, it still is not clear to the user what the new number literally means, why the change was determined, and exactly what the change represents.

It will be appreciated that many variations are possible for practicing the invention without departing from the spirit of the present invention. For example, a first alternative method in accordance with the present invention computes a responsive confidence score without having generated a reference table of correspondence. The first alternative method obtains a subject property identification and suggested valuation from the customer and provides an AVM valuation and preliminary confidence score for the subject property. The first alternative method next accesses a data set of sold properties, provides AVM valuations and preliminary confidence scores for those sold properties, sorts the properties into subsets according to preliminary confidence score, computes directive confidence scores for the subsets, selects a subset appropriate for generating a responsive confidence score for the subject property, and computes and reports the responsive confidence score. A variation on the first alternative method computes a score for the subject property from data for a subset which is selected without first computing directive confidence scores.

The first alternative method is now described (a description of the variation on the first alternative method will follow). In the first alternative method in accordance with the present invention, a processor implemented on a general purpose computer is operatively connected to a customer interface, an automated valuation model, and a database containing real property historical sale price data. A customer who contemplates a transaction involving a particular real property, “the subject property,” wishes to propose a particular valuation of the subject property. Through the user interface the method accepts from the customer a SUBJECT PROPERTY ID (e.g., address; any data sufficient to identify the property) and a SUBJECT PROPERTY SUGGESTED VALUATION (the valuation this customer wishes to propose) and creates a SUBJECT PROPERTY DATA RECORD having fields for at least these two data.

In accordance with this first alternative method, the processor carries out or invokes the services of an automated valuation model (“AVM”) to obtain a valuation of the subject property. The processor passes to the AVM one argument, namely, SUBJECT PROPERTY ID. Based on this argument, the AVM returns two data: a SUBJECT PROPERTY DIRECTIVE AVM VALUATION and a SUBJECT PROPERTY PRELIMINARY CONFIDENCE SCORE. The processor accepts these two data from the AVM and adds them to the SUBJECT PROPERTY DATA RECORD. The SUBJECT PROPERTY DATA RECORD now contains at least four fields:
SUBJECT PROPERTY ID;
SUBJECT PROPERTY SUGGESTED VALUATION;
SUBJECT PROPERTY DIRECTIVE AVM VALUATION; and
SUBJECT PROPERTY PRELIMINARY CONFIDENCE SCORE.

In accordance with this first alternative method, the processor computes the percentage by which the SUBJECT PROPERTY SUGGESTED VALUATION exceeds the SUBJECT PROPERTY DIRECTIVE AVM VALUATION. This percentage is hereinafter referred to as the SUBJECT PROPERTY ADJUSTMENT FACTOR, denominated by the letter “a” and is included as a fifth field of the SUBJECT PROPERTY DATA RECORD.

In accordance with this first alternative method, the processor utilizes the database containing real property historical sale price data to identify a data set of property sale transactions. The processor creates a set of SOLD PROPERTY DATA RECORDS each including a SOLD PROPERTY IDENTIFICATION and a SOLD PROPERTY SALE PRICE.

For each SOLD PROPERTY DATA RECORD, the processor invokes an AVM, passing to the AVM the SOLD PROPERTY IDENTIFICATION. The AVM returns a SOLD PROPERTY AVM VALUATION and a SOLD PROPERTY PRELIMINARY CONFIDENCE SCORE. The processor adds these values to each SOLD PROPERTY DATA RECORD.

The result is a data set of SOLD PROPERTY DATA RECORDS each having the following four fields:
SOLD PROPERTY IDENTIFICATION;
SOLD PROPERTY SALE PRICE;
SOLD PROPERTY AVM VALUATION; and
SOLD PROPERTY PRELIMINARY CONFIDENCE SCORE.

In accordance with this first alternative method, the processor sorts the SOLD PROPERTY DATA RECORDS into subsets according to each record's SOLD PROPERTY PRELIMINARY CONFIDENCE SCORE. For each subset, the processor determines the percentage of the subset's properties that were more than ten percent overvalued by the AVM. This overvaluation is expressed algebraically by the inequality,
“(SOLD PROPERTY AVM VALUATION/SOLD PROPERTY SALE PRICE)>1.10”
For each property in the subset, the processor sets an indicator variable at 1 if the property is over ten percent overvalued, and at 0 if not, then sums the indicator variables for the subset and divides by the number of properties in the subset. This percentage is then subtracted from 1 (i.e., from 100%) to yield a SOLD PROPERTY DIRECTIVE CONFIDENCE SCORE for each subset.

In accordance with this first alternative method, the processor next selects the subset of the overall data set whose SOLD PROPERTY DIRECTIVE CONFIDENCE SCORE is equal to the SOLD PROPERTY DIRECTIVE CONFIDENCE SCORE derived from the set of all properties in the data set having SOLD PROPERTY PRELIMINARY CONFIDENCE SCORE equal to the SUBJECT PROPERTY PRELIMINARY CONFIDENCE SCORE. It is possible that more than one level of PRELIMINARY CONFIDENCE SCORE will be associated with a single DIRECTIVE CONFIDENCE SCORE. The processor determines the percentage of the properties in this subset for which the expression,
“(SOLD PROPERTY AVM VALUATION/SOLD PROPERTY SALE PRICE)>[(1.10)/(1+a)],”
is true, where the value of “a” is fixed at the value of the SUBJECT PROPERTY ADJUSTMENT FACTOR. Once again, setting an indicator variable, summing, and dividing is a convenient way of determining this percentage. Specifically, the indicator variable is set at 1 if the expression is true and 0 if not. The indicator variables for all properties in the subset are summed. The sum is divided by the number of properties in the subset. The resulting quotient is subtracted from 1 (i.e., from 100%) and converted into a two-digit number to yield a SUBJECT PROPERTY RESPONSIVE CONFIDENCE SCORE.

This first alternative method may be useful in a situation where a relatively small data set is to be used, where different data sets are being experimented with, or where one is willing to perform a large number of computations each time a responsive score is to be generated.

In accordance with the present invention, in a variation on this first alternative method, a variant type of confidence score can be generated without the step of determining the directive confidence score for each subset of sold properties. Instead, the variant score is computed by performing the aforementioned step of testing the inequality,
“(SOLD PROPERTY AVM VALUATION/SOLD PROPERTY SALE PRICE)>[(1.10)/(1+a)],”
on the subset whose sold property preliminary confidence score equals the subject property preliminary confidence score, setting the indicator variables, summing, dividing, and subtracting as set forth above. In this variation, no directive confidence score is computed, and there is no combining or reassociation of subsets having distinct preliminary confidence scores. The resulting responsive confidence score can be reported to the customer as a confidence score for the subject property in response to the customer's request. This confidence score, while not preferred, may be useful in a situation where limited data or computational resources are available.

A second alternative method in accordance with the present invention builds a reference table of correspondence and reports a responsive confidence score without performing any additional steps of adjusting entries in the reference table of correspondence for monotonicity. This second alternative method selects from the reference table of correspondence the entry appropriate to the subject property. The second alternative method obtains a subject property identification and suggested valuation from the customer and provides an AVM valuation and preliminary confidence score for the subject property. The second alternative method next accesses a data set of sold properties, provides AVM valuations and preliminary confidence scores for those sold properties, sorts the properties into subsets according to preliminary confidence score, and computes directive confidence scores for the subsets. Next, the second alternative method generates a reference table of correspondence whose entries are responsive confidence scores associated with a range of values of an adjustment factor and a range of values of the directive confidence scores of the subsets of sold properties. Finally, the second alternative method selects from the reference table of correspondence (this table not having been adjusted for monotonicity) an entry appropriate for generating a responsive confidence score for the subject property, and computes and reports the responsive confidence score. A variation on the second alternative method generates a reference table of correspondence from the data in the sold property subsets without first computing directive confidence scores for the subsets. Thus, the entries of the table in the variation on the second alternative method are associated with a range of values of an adjustment factor and a range of preliminary confidence scores. The variation on the second alternative method then selects from the table an entry appropriate for the subject property and reports to the customer a score based on that entry.

The second alternative method is now described (a description of the variation on the second alternative method will follow). In the second alternative method, the SUBJECT PROPERTY DATA RECORD is established containing at least the following five fields:
SUBJECT PROPERTY ID;
SUBJECT PROPERTY SUGGESTED VALUATION;
SUBJECT PROPERTY DIRECTIVE AVM VALUATION;
SUBJECT PROPERTY PRELIMINARY CONFIDENCE SCORE, and
SUBJECT PROPERTY ADJUSTMENT FACTOR.

In the second alternative method, the processor utilizes the database containing real property historical sale price data to identify a data set of property sale transactions. The processor creates a set of SOLD PROPERTY DATA RECORDS each including a SOLD PROPERTY IDENTIFICATION and a SOLD PROPERTY SALE PRICE.

In the second alternative method, for each SOLD PROPERTY DATA RECORD, the processor invokes an AVM, passing to the AVM the SOLD PROPERTY IDENTIFICATION. The AVM returns a SOLD PROPERTY AVM VALUATION and a SOLD PROPERTY PRELIMINARY CONFIDENCE SCORE. The processor adds these values to each SOLD PROPERTY DATA RECORD.

The result is a data set of SOLD PROPERTY DATA RECORDS each having the following four fields:
SOLD PROPERTY IDENTIFICATION;
SOLD PROPERTY SALE PRICE;
SOLD PROPERTY AVM VALUATION; and
SOLD PROPERTY PRELIMINARY CONFIDENCE SCORE.

In accordance with this second alternative method, the processor sorts the SOLD PROPERTY DATA RECORDS into subsets according to each record's SOLD PROPERTY PRELIMINARY CONFIDENCE SCORE. For each subset, the processor determines the percentage of the subset's properties that were more than ten percent overvalued by the AVM. This overvaluation is expressed algebraically by the inequality,

“SOLD PROPERTY AVM VALUATION/SOLD PROPERTY SALE PRICE)>1.10”

For each property in the subset, the processor sets an indicator variable at 1 if the property is over ten percent overvalued, and at 0 if not, then sums the indicator variables for the subset and divides by the number of properties in the subset. This percentage is then subtracted from 1 (i.e., from 100%) to yield a SOLD PROPERTY DIRECTIVE CONFIDENCE SCORE for each subset.

In accordance with this second alternative method, the processor constructs a reference table of correspondence. In this table, each row corresponds to a single value of the SOLD PROPERTY DIRECTIVE CONFIDENCE SCORE. Each column corresponds to a value of a variable named “a,” for which the processor generates a set of 21 values ranging from “a”=−10% to “a”=+10%.

The processor computes the entries in this reference table of correspondence over the range of values of “a” and over the entire range of values of the SOLD PROPERTY DIRECTIVE CONFIDENCE SCORE. For each value of “a,” the processor computes a column of entries, each entry in the column being derived with reference to one value of “a” and with reference to the subset of SOLD PROPERTY DATA RECORDS whose SOLD PROPERTY DIRECTIVE CONFIDENCE SCORE has the value for that row. Thus, in the reference table of correspondence, each row corresponds to a particular value of the SOLD PROPERTY DIRECTIVE CONFIDENCE SCORE and each column corresponds to a particular value of “a.”

To compute each entry in this reference table of correspondence, the processor obtains the entry column's value of “a,” identifies the subset of SOLD PROPERTY DATA RECORDS whose SOLD PROPERTY DIRECTIVE CONFIDENCE SCORES have the entry row's value, and performs a procedure with reference to this value of “a” and the entire subset.

The procedure is as follows: for each SOLD PROPERTY DATA RECORD in the subset, the processor sets an indicator variable value at 1 if the expression
(SOLD PROPERTY AVM VALUATION/SOLD PROPERTY SALE PRICE)>[(1.10)/(1+a)],”
is true of that SOLD PROPERTY DATA RECORD given the entry column's value of “a,” and is 0 if the same statement is false, where the SOLD PROPERTY DIRECTIVE AVM VALUATION and the SOLD PROPERTY SALE PRICE are obtained from the SOLD PROPERTY DATA RECORD being tested. The processor sums the indicator variable values, divides by the number of properties in the subset, and subtracts the resulting quotient from 1 (i.e., from 100%). This difference, converted into a two-digit numerical score, becomes the entry in the reference table of correspondence for the entry column's value of “a” and the entry row's value of SOLD PROPERTY DIRECTIVE CONFIDENCE SCORE.

After computing all entries in the reference table of correspondence, the processor selects an entry from the reference table of correspondence by identifying the row whose SOLD PROPERTY DIRECTIVE CONFIDENCE SCORE equals the DIRECTIVE CONFIDENCE SCORE associated with the set of sold properties whose PRELIMINARY CONFIDENCE SCORE is the same as the SUBJECT PROPERTY PRELIMINARY CONFIDENCE SCORE and the column whose “a” value equals the SUBJECT PROPERTY ADJUSTMENT FACTOR. Only one entry in the table corresponds to this row and column. This entry is the SUBJECT PROPERTY RESPONSIVE CONFIDENCE SCORE. The processor reports it to the customer via the customer interface. The procedure is the same as in the preferred embodiment, except that the table of correspondence is not adjusted for monotonicity.

A variation on the second alternative method is now described. In accordance with the present invention, in a variation on this second alternative method, a variant type of confidence score can be generated without the step of determining the directive confidence score for each subset of sold properties. Instead, the variant score is computed based on a reference table of correspondence whose entries are computed by performing the aforementioned step of testing the inequality,
“(SOLD PROPERTY AVM VALUATION/SOLD PROPERTY SALE PRICE)>[(1.10)/(1+a)],”
on each subset of sold properties, for each value of “a,” in the manner described above, where each row in the table corresponds to a single value of the sold property preliminary confidence score. The steps are carried out: setting the indicator variables, summing, dividing, and subtracting as set forth above. Ultimately, the entry is selected whose column corresponds to the subject property adjustment factor and whose row corresponds to the sold property preliminary confidence score which is equal to the subject property preliminary confidence score. This entry can be reported to the customer as a confidence score for the subject property, in response to the customer's request. This variant confidence score, while not preferred, may be useful in a situation where limited data or computational resources are available. Again, no adjustments for monotonicity are made.

Of course, the preferred method is regarded as providing the best combination of advantages, including the advantages of adjusting for monotonicity. Nevertheless, the first and second alternative methods and variants thereof are described to more thoroughly illustrate the scope of the present invention. It will also be understood that the present invention is not to be limited in its implementation with respect to the architecture of the processor or network that supports it. The customer interface, the AVM, and the various data records and databases referenced in the description of the present invention may be resident on one computing machine or many, and may be carried out once or many times. Property identifications and suggested valuations need not be supplied only by a customer, but also by any other process that generates them, singly or in batches. They may be used not only to generate responsive confidence scores, but to test different data sets for usefulness in computing responsive confidence scores.

A third alternative variation on the present invention follows the same method as the preferred embodiment, or, alternatively, any of the previously described alternative variations, except that the original level of unacceptable overvaluation is modified from ten percent to eight percent, twelve percent, fifteen percent, or any other fixed level. In such a variation, the formulas and methods remain the same, except that, for example, “1. 10” is replaced throughout by “1.08” or “1.12” or “1.15” or whatever fixed number is appropriate.

Accordingly, the scope of the present invention is to be limited only by the claims appended to this specification.

1. A method of computing a responsive confidence score in response to a suggested valuation of a subject property, using a computer system, comprising the steps of:
inputting into the computer system identity data of the subject property;
inputting into the computer system the suggested valuation of the subject property; and
computing a responsive confidence score for the suggested valuation of the subject real property.

2. The method as described in claim 1 wherein said responsive confidence score is computed using a reference table on a tangible medium.

3. The method as described in claim 2 further including the steps of
inputting into the computer system a directive valuation of the subject property;
computing a difference between the directive valuation and the suggested valuation; and
inputting the directive valuation, the suggested valuation and a difference between them into said reference table;
to thereby compute a responsive confidence score for the suggested valuation of the subject real property.

4. The method as described in claim 3 wherein said directive valuation is computed using an automated valuation model.

5. The method as described in claim 3 wherein said automated valuation model provides a directive valuation having a directive confidence score.

6. The method as described in claim 4 wherein said directive confidence score associated with said directive valuation is inputted into the computer.

7. The method as described in claim 3 wherein said confidence score of said automated valuation model is based on a predetermined percentage probability of unacceptable excess valuation.

8. The method as described in claim 3 wherein the difference between the directive valuation and the suggested valuation is computed as a percentage difference.

9. The method as described in claim 2 wherein the reference table is constructed by
computing a plurality of directive confidence scores based on sales prices of a plurality of previously sold properties;
computing adjusted confidence scores which are different from the associated directive confidence scores; and
adjusting the table for monotonicity.

10. The method as described in claim 9 wherein each directive confidence score is a numerical score of the percentage probability of unacceptable excess valuation.

11. The method as described in claim 3 wherein said directive valuation is computed using an automated valuation model.

12. The method as described in claim 11 wherein the automated valuation model provides a directive valuation having a confidence score.

13. The method as described in claim 12 wherein the confidence score of the automated valuation model is based on a predetermined percentage probability of unacceptable excess valuation.

14. The method as described in claim 3 wherein the difference between the directive valuation and the suggested valuation is computed as a percentage difference.

15. The method as described in claim 2 wherein the reference table is constructed by:
computing a set of automated valuations and automated directive confidence scores for a plurality of properties for which actual sale prices are known; and
computing a responsive confidence score with reference to said set of computed automated valuations and automated directive confidence scores, said actual sale prices, and said suggested valuation of said subject property.

16. A method as set forth in claim 1, including the steps of:
providing a subject property AVM valuation and a subject property preliminary confidence score; and
computing said responsive confidence score with reference to said subject property AVM valuation, said subject property preliminary confidence score, and said suggested valuation of said subject property.

17. A method as set forth in claim 16, further comprising the steps of:
providing a data set including a plurality of sold properties and a sold property sale price for each of said sold properties;
providing a sold property AVM valuation and a sold property preliminary confidence score for each sold property in said data set;
dividing said data set into subsets each containing only properties having a single value of the sold property preliminary confidence score;
for each said subset, determining a first percentage of properties therein whose sold property AVM valuation divided by said sold property sale price exceeds a first overvaluation criterion;
for each said subset, determining a sold property directive confidence score with reference to said first percentage and associating said sold property directive confidence score of said subset with each property in said subset;
from said data set, selecting all properties whose said directive confidence score equals the directive confidence score of the subset whose preliminary confidence score equals said preliminary confidence score of said subject property;
for said selected properties, determining a second percentage thereof for which said sold property AVM valuation divided by said sold property sale price exceeds a second overvaluation criterion; and
determining a responsive confidence score for subject property with reference to said second percentage.

18. A method as set forth in claim 17, wherein said first overvaluation criterion is fixed at a predetermined level of unacceptable excess valuation.

19. A method as set forth in claim 17, wherein said second overvaluation criterion is determined with reference to a subject property adjustment factor.

20. A method as set forth in claim 16, further comprising the steps of:
providing a data set including a plurality of sold properties and a sold property sale price for each of said properties;
providing a sold property AVM valuation and a sold property preliminary confidence score for each sold property in said data set;
sorting said data set into preliminary subsets according to the value of said sold property preliminary confidence score;
for each said preliminary subset, determining a first percentage of properties therein for which said sold property AVM valuation divided by said sold property sale price exceeds a first overvaluation criterion;
for each said preliminary subset, determining a sold property directive confidence score with reference to said first percentage and associating said sold property directive confidence score of said subset with each property in said subset;
sorting said data set into secondary subsets according to the value of said sold property directive confidence score of each property in said data set;
generating a plurality of numerical values representing a range of property adjustment factors;
for each of said numerical values, for each of said secondary subsets, determining a second percentage of properties for which said sold property AVM valuation divided by said sold property sale price exceeds a second overvaluation criterion, said second overvaluation criterion being determined with reference to said numerical value;
for each said numerical value, for each of said secondary subsets, determining a responsive confidence score with reference to said second percentage;
selecting the secondary subset whose said sold property directive confidence score is equal to said sold property directive confidence score of said preliminary subset whose said sold property preliminary confidence score equals said subject property preliminary confidence score; and
providing the responsive confidence score for the subject property by selecting, from said responsive confidence scores of said selected secondary subset, the responsive confidence score that results when the numerical value is fixed at the value of said subject property adjustment factor.

21. A method as set forth in claim 20, wherein said first overvaluation criterion is fixed at a predetermined level of unacceptable excess valuation.

22. A method as set forth in claim 20, wherein said second overvaluation criterion is defined by the algebraic statement,
“(SOLD PROPERTY AVM VALUATION/SOLD PROPERTY SALE PRICE) [symbol] [(1+first overvaluation criterion)/(1+property adjustment factor)],”

23. A method as set forth in claim 20, including the step, after said step of determining said responsive confidence score for each of said subsets at each of said values of said property adjustment factor of:
identifying, among said responsive confidence scores resulting from a plurality of said subsets at a single value of said property adjustment factor, a sequence of said responsive confidence scores which does not vary monotonically with respect to said directive confidence scores of said subsets; and
within said sequence, changing a responsive confidence score by an amount sufficient that said sequence varies monotonically with respect to said directive confidence scores of said subsets.

24. A method as set forth in claim 16, further comprising the steps of:
providing a data set including a plurality of sold properties and a sold property sale price for each of said sold properties;
providing a sold property AVM valuation and a sold property preliminary confidence score for each sold property in said data set;
determining, for each sold property in said data set, whether said sold property AVM valuation divided by said sold property sale price exceeds a predetermined overvaluation criterion, said overvaluation criterion being determined with reference to said subject property AVM valuation and said suggested valuation of said subject property;
selecting a subset of said sold properties for which said sold property preliminary confidence score is equal to said subject property preliminary confidence score;
determining the proportion of sold properties in said subset for which said sold property AVM valuation exceeds said sold property sale price by said overvaluation criterion; and
determining said responsive confidence score of the subject property with reference to said proportion.

25. A method as set forth in claim 16, further comprising the steps of:
providing a data set including a plurality of sold properties and a sold property sale price for each of said properties;
providing a sold property AVM valuation and a sold property preliminary confidence score for each sold property in said data set;
sorting said data set into subsets according to the value of said preliminary confidence score;
determining, for each property in said data set, whether said sold property AVM valuation divided by said sold property sale price exceeds a predetermined overvaluation criterion;
for each of said subsets, determining the proportion of properties in said subset for which said sold property AVM valuation divided by said sold property sale price exceeds a predetermined overvaluation criterion;
selectively modifying the value of said proportion, where said proportion does not vary monotonically with said preliminary confidence score, such that said proportion, as modified, varies monotonically with said preliminary confidence score;
selecting a subset of said properties for which said preliminary confidence score has a particular value; and
after said step of selectively modifying has been performed, determining said responsive confidence score of the subject property with reference to the value of said proportion for said selected subset, said preliminary confidence score of said subject property, and said suggested valuation of said subject property.

26. A method of providing a responsive confidence score in response to a proposed valuation of a subject property, using a computer system, the method comprising the steps of:
obtaining identifying information about the subject property;
obtaining a proposed valuation of the subject property;
providing a directive automated valuation and a directive automated confidence score for the subject property;
computing a valuation adjustment factor based on a percentage difference between said proposed valuation by said automated valuation; and
providing a responsive confidence score determined with reference to said valuation adjustment factor and said automated confidence score.

27. The method as set forth in claim 26, wherein said step of providing said responsive confidence score includes the steps of:
maintaining a reference table of correspondence in the computer system, said reference table of correspondence providing a responsive confidence score table entry associated with an ordered pair comprising said valuation adjustment factor and said automated confidence score;
identifying the entry therein associated with said valuation adjustment factor and said automated confidence score; and
reporting a responsive confidence score determined as a function of said entry.

28. The method as set forth in claim 27, wherein said step of maintaining a reference table of correspondence in said computer system includes the steps of:
maintaining in said computer system a data set of properties for which both a directive AVM valuation and a known sale price is available;
determining, for each of said set of properties in said data set, whether a right tail error is committed at each of a plurality of values of said valuation adjustment factors;
determining, with reference to said data set of properties, a probability of right tail error associated with each of said plurality of adjustment factors; and
selecting one probability value associated with said determined values of said valuation adjustment factor and said automated confidence score; and
reporting a responsive confidence score computed as a function of said selected probability value.

29. The method as set forth in claim 26, wherein said percentage difference is computed by dividing said proposed valuation by said automated valuation.

30. A reference table for use in computing a responsive confidence score for a suggested valuation of a subject real property, said reference table being fixed on a tangible medium and computed by the following method:
computing a plurality of directive confidence scores based on sales prices of a plurality of the previously sold properties;
computing adjusted confidence scores for suggested valuations which are different from the associative directive confidence scores; and
adjusting the table for monotonicity.

31. The method of claim 30 wherein the directive confidence score is computed using an automated valuation model.

32. The method as described in claim 31 wherein said automated valuation model provides a directive valuation having a confidence score.

33. The method as described in claim 32 wherein the automated valuation model is based on a predetermined percentage probability of unacceptable excess valuation.
